(19) United States
(12) Patent Application Publication
(10) Pub. No.: US 2002/0156842 A1
(43) Pub. Date: Oct. 24, 2002

(54) System for audio-visual media customization according to receiver attributes

(75) Inventors: Julien Signes, San Francisco, CA (US); Rahul Tyagi, San Jose, CA (US); Eric Deniau, La Baussaine (FR)

Correspondence Address: SWERNOFSKY LAW GROUP PC, P.O. BOX 390013, MOUNTAIN VIEW, CA, 94039-0013, US

(73) Assignee: Envivio, South San Francisco, CA

(21) Appl. No.: 10/076,866

(22) Filed: Feb. 13, 2002

Related U.S. Application Data
(60) Provisional application No. 60/285,942, filed on Apr. 23, 2001.

(51) Int. Cl. G06F 15/16; H04N 7/10; H04N 7/025; G06F 17/30

(52) U.S. Cl. 709/203; 725/34; 707/1; 709/219; 709/231

(57) ABSTRACT

The invention provides a technique for integrating a plurality of media streams, including a main program and a stream of customized information at a terminal so that a user gets a single playback. Prior to streaming a main program to a user, the main program is embedded with placeholders. These placeholders include a definition of a location for insertion of customized media content and a pointer to another server. As the user receives the main program and embedded placeholders, these pointers get directed from the user's terminal to streaming server, which responds by identifying appropriate media and streaming the media to the user's terminal. Software on the user's terminal (also known as a “player”) integrates the various data streams and synchronizes them to a main program. The user's terminal may receive many media streams from different streaming servers and integrate each stream into a single playback.

### BACKGROUND OF THE INVENTION

1. Field of the Invention

This invention relates to receiving and integrating a plurality of media streams into a single display.

2. Related Art

The art of presenting audiovisual content has progressed to where it is possible to send media information from more than one server to a specific client, and to present a combination of that media information at the client, for the benefit of an individual user. This is distinct from existing broadcast media, in which the media content is intended for a large audience, and is identical for all receivers. Techniques for sending media include sending a stream of messages including information for presentation of the media; such techniques (and the messages themselves) are called “streaming media.”

In addition to presenting streaming media to an individual user in response to that user's request, it would be advantageous to customize or personalize that streaming media according to the receiver or user attributes (for example, to include stories or advertising of particular relevance to the given user). However, personalizing streaming media is not the same as (and consequently, poses problems that are different from) personalizing hypertext, which is parsed, and in which the parsed elements can point to particular personalized content. For personalizing streaming media, the personalized content is both (1) inserted for presentation at a particular temporal point, and (2) inserted for presentation instead of or in addition to specific media content.

Accordingly, it would be desirable to provide a new technique for providing customized content in streaming media.

### SUMMARY OF THE INVENTION

The invention provides a method and system in which a plurality of media streams, including a main program and a set of customized information, are received at a terminal that is under the control of an end-user and are combined for presentation so that the user views a single, integrated display.

Prior to streaming a main program to an end user, a content creator embeds the streaming media with placeholders, such that each placeholder can be used for subsequent insertion of customized content. These placeholders include (1) a definition of a temporo-spatial location for insertion of customized media objects, (2) a pointer to a server location where the customized objects are located, (3) a set of attributes (for example, location, size and transparency level), and (4) an identifier of the user who is the intended recipient of the customized media objects. As the user receives the main program and embedded placeholders, these pointers get directed from the user's terminal to the appropriate server location, which responds by identifying appropriate information associated with the user and streams the information to the user's terminal. Software on the user's terminal (also known as a “player”) integrates the various data streams as they are received and synchronizes them to the main streaming media presentation. In a preferred embodiment, the user's terminal may receive a number of different media streams from a number of different servers and integrates each stream into a single display for presentation.

### BRIEF DESCRIPTION OF THE DRAWINGS

FIG. 1 shows a block diagram of a system for receiving and integrating a plurality of media streams at a user station and integrating them into a single display.

FIG. 2 shows a process flow diagram of a method for receiving and integrating a plurality of media streams at a user station and integrating them into a single display.

### DESCRIPTION OF THE PREFERRED EMBODIMENT

The invention is described herein with regard to preferred steps and data structures. Those skilled in the art will recognize, after perusal of this application, that the described steps and data structures are not limited to any particular processing devices (whether general-purpose or special-purpose processing devices, or specific circuitry). Rather, those of ordinary skill in the art would be able to implement the described steps and data structures, and equivalents thereof, without undue experimentation or further invention. All such implementations are within the scope and spirit of the invention.

Lexicography

client and server—as used herein, the phrases, “client” and “server” refer to a relationship between two devices, particularly to their relationship as client and server, not necessarily to any particular physical devices.

client device and server device—as used herein, the phrase “client device” includes any device taking on the role of a client in a client-server relationship (such as an HTTP web client and web server). There is no particular requirement that any client devices must be individual physical devices; they can each be a single device, a set of cooperating devices, a portion of a device, or some combination thereof. As used herein, the phrase “server device” includes any device taking on the role of a server in a client-server relationship. There is no particular requirement that server devices must be individual physical devices; they can each be a single device, a set of cooperating devices, a portion of a device, or some combination thereof.

streaming media—in general, a time-varying sequence of data (including images or information) intended for presentation to a recipient. For example, streaming media can include animation, audio information, motion picture or media information, still pictures in sequence, or other time-varying data. In a more general sense, streaming media can include non-visual data such as stock market information or telemetry.

System Elements

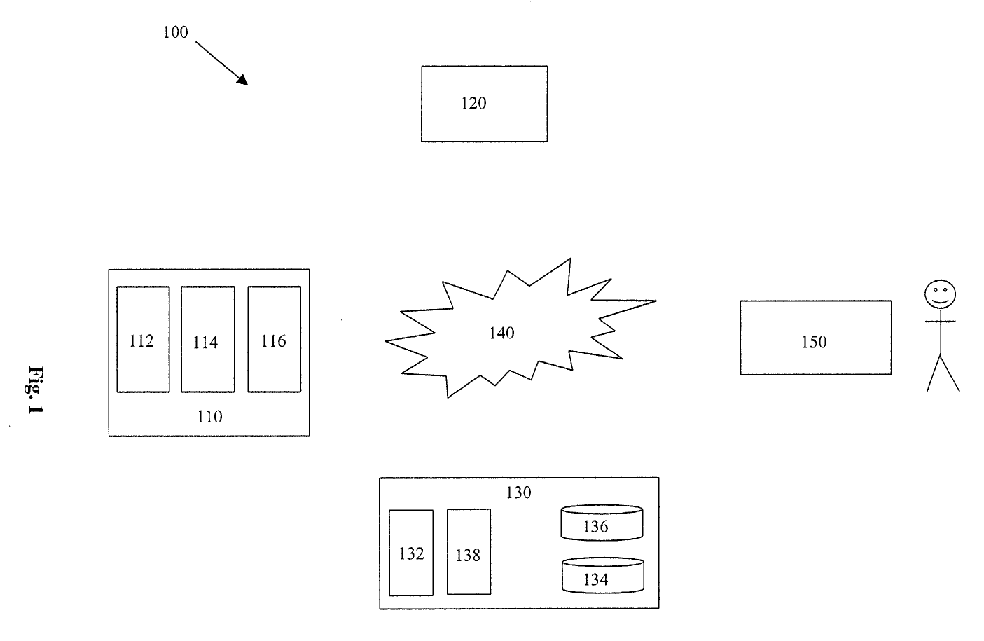

FIG. 1 shows a block diagram of a system for receiving and integrating a plurality of media streams at a user station and integrating them into a single display.

A system for receiving and integrating a plurality of media streams (shown by general character reference 100) includes an authoring workstation 110, a streaming server 120, a media server 130, a communication link 140, and a terminal 150 under the control of an end user 155.

The authoring workstation 110 includes generic media content 112 and a set of authoring tools 114 that are used by a content creator in the post-production phase of media production. In a preferred embodiment, the media content 112 includes a main presentation (“program”), such as a “live” video (for example, car races and other sporting events), or may be derived from a media library, such as a library of VoD (video on demand) programs. The content creator uses the authoring tools 114 to insert one or more placeholders 116 into the media content 112 so that different types of media can be mixed together to form a single scene.

The placeholders 116 each include an indicator for the temporo-spatial insertion of personalized content, a set of attributes (such as location, size and transparency level), and a pointer to a location where that personalized content may be obtained. When an end user 155 watches a scene that includes a placeholder 116, the terminal 140 receives both the generic media 112 and the placeholder 116 from the streaming server 120. The placeholder 116 prompts the terminal 140 to interact with the media server 130, causing the media server 130 to send additional media to the end user 155. In one embodiment, the placeholder 116 appears as a “hole” if the additional media is not sent. In alternative embodiments, the placeholder 116 includes an underlying video or a still image that are visible to the end user 155 if the additional media is not sent.

Both the generic media content 112 and the media associated with the placeholder 116 include any type of media that can be rendered in MPEG, including graphics, video, still images, animation, short film clips, audio and java scripts.

The streaming server 120 includes sufficient server software so as to transmit both the media content 112 and the placeholders 116 to the terminal 150. The streaming server 120 can send this media content 112 either in multicast or unicast form. Multicasting involves sending the same content to more than one end user 155. Unicasting involves sending content that is targeted to a single end user 155. In a preferred embodiment, the streaming server 120 is logically coupled to the authoring workstation 110.

The media server 130 includes a dispatcher 132, a content database 134, a user database 136 and a rule engine 138.

The dispatcher 132 receives requests for customized information from the terminal 150 and processes the requests. Processing the requests includes (1) redirecting the streaming requests to the adequate streaming server 120 so as to distribute the requests for load balancing purposes, and (2) identifying appropriate media that is responsive to the placeholder 116 and the identification of the terminal 150.

The content database 134 is a relational or object-oriented database that includes a library of customized content organized in such a way that the customized content matches the types of attributes found in the user database 136. This customized content can include advertisements, specialized messages, reminders about specific upcoming events, updates with respect to sporting scores or news and other types of content that may be of interest to a particular end user 155. The association between a particular attribute and a particular piece of customized content is responsive to decisions made by a business or marketing expert.

The user database 136 is a relational or object-oriented database that includes a set of attributes, a listing of user IDs and a set of associations between the various attributes and the user IDs. These attributes are used to determine what types of customization are appropriate for a particular end user 155. For example, the attributes include (without limitation) the gender, age, language, and address of an end user 155, along with a listing of sports preferences, hobbies, income, marital status and other features that may be useful in determining appropriate customized content. In a preferred embodiment, the content database 134 can be updated with information on particular end users 155, such as can be obtained commercially or provided by the end user 155 when they register their terminal 150. The user database 136 can be updated to account for new end users 155 and their associated terminal identification or to respond to changes involving old end users 155.

The rule engine 138 includes tools to compute a customized media according to the combination of the user ID, content database 134 and user database 136. The rule engine 138 follows a two-step process to determine what customized content to present to the end user 155. Upon receiving the placeholder 116, the rule engine 138 looks first to the user database 136 to associate the user ID included in the placeholder 116 with various user attributes. Second, the rule engine 138 looks to the content database 134 to identify content that is associated with those specific attributes. In the event that several different types of content can be matched to the placeholder 116, the rule engine 138 determines which of those content types is sent to the terminal 150.

The communication link 140 can include a computer network, such as an Internet, intranet, extranet or a virtual private network. In alternative embodiments, the communication link 140 can include a direct communication line, a switched network such as a telephone net-work, a wireless network, a form of packet transmission or some combination thereof. All variations of communication links noted herein are also known in the art of computer communication. In a preferred embodiment, the authoring station 110, the streaming server 120, the media server 130 and the terminal 140 are coupled by the communication link 130.

The terminal 150 includes a buffer for storing media, and circuitry or software for integrating and synchronizing the data streams from the several streaming servers 120. In a preferred embodiment, each terminal 150 is under the control of an end user 155 and is associated with a user ID that is used by the media server 130 to determine appropriate customized information appropriate to the end user 155. The terminal 150 receives, buffers, decodes and plays back an MPEG 4 presentation that includes the requested media stream and associated other media streams, including those that provide customized content.

Method of Operation

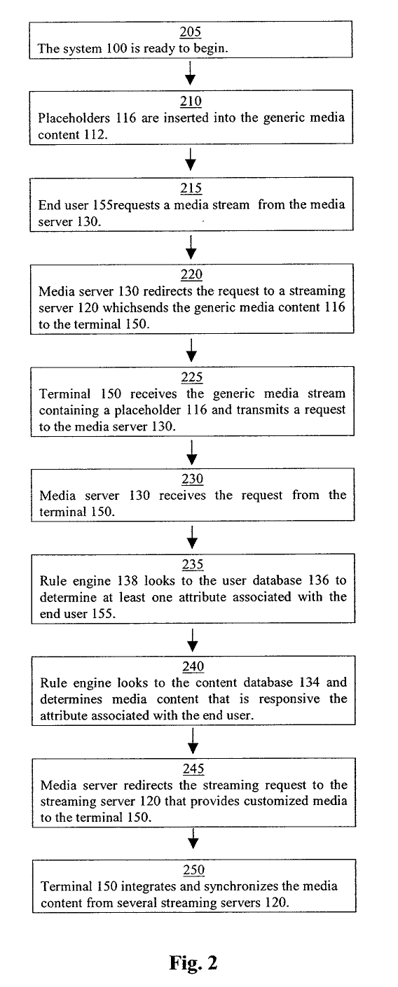

FIG. 2 shows a process flow diagram of a method for receiving and integrating a plurality of media streams at a user station and integrating them into a single display.

The method 200 is performed by the system 100. Although the method 200 is described serially, the steps of the method 200 can be performed by separate elements in conjunction or parallel, whether asynchronously, in a pipelined manner, or otherwise. There is no particular requirement that the method 200 be performed in the same order in which this description lists the steps, except where so indicated.

In a flow point 205, the system 100 is ready to begin providing personalized content in streaming media.

At a step 210, a content creator uses an authoring workstation 110 to review generic media content 112 and insert one or more placeholders 116 into the generic media content 112. The placeholders 116 include a set of attributes (for example, location, size and transparency level) and a pointer to a server 120 where the personalized content may be obtained.

In a step 215, an end user 155 manipulates a mouse, a remote controller or other pointing device associated with the terminal 150 and requests a media stream. Generally, this request is made to the media server 130.

In a step 220, the media server 130 redirects the request to a streaming server 120 that can provide the generic media content 112 to the terminal 150. The streaming server 120 begins sending the generic media content 116 to the terminal 150. The generic media content 112 includes at least one placeholder 116.

In a step 225, the terminal 150 receives the generic media stream containing a placeholder 1 16. Upon identifying the placeholder 116, the terminal 150 transmits a request to the media server 130. During this step, the terminal 150 continues to receive and buffer the media stream from the streaming server 120.

In a step 230, the media server 130 receives the request from the terminal 150.

In a step 235, the rule engine 138 looks to the user database 136 to determine at least one attribute associated with the end user 155. This attribute may include such factors as the age, gender, language, income bracket, marital status, hobbies or other descriptors of a particular end user 155.

In a step 240, the rule engine looks to the content database 134 to determine a particular media content that is responsive to the request based upon an association between the terminal identification stored in the user data base 136 and content stored in the content data base 134. Examples of a responsive media content may include

local advertising based upon geographical location of the end user

advertising tailored to a end users' interests, age, gender, language or profession

branding or access to specific services related to the end-user subscription

updates on specific topics of interest to an end user such as sports scores

product updates relating to products owned by the end user

other information such as be of interest to the end user.

At a step 245, the media server redirects the streaming request to the streaming server 120 that can provide the customized media to the terminal 150.

At a step 250, the terminal 150 integrates and synchronizes the media content from several streaming servers 120. In a preferred embodiment, the terminal 150 may receive content from any number of servers. For example, individual placeholders 116 may be directed to many different streaming servers 120, each of which provides a media stream that is integrated by the terminal 150.

Alternative Embodiments

Although preferred embodiments are disclosed herein, many variations are possible which remain within the concept, scope and spirit of the invention; these variations would be clear to those skilled in the art after perusal of this application.

1. A server, including
a software module that receives at least one media stream, wherein said at least one media stream includes a placeholder;
a software module that receives and parses a request from a user; and
a software module that generates a specific media content, wherein said specific media content is responsive to said request.

2. A server, as in claim 1, wherein said placeholder includes a temporo-spatial point in said at least one media stream for insertion of said specific media content and a location where said specific media content may be obtained.

3. A server as in claim 1, including a first database wherein said first database includes information relating to a set of users.

4. A server as in claim 3, wherein said first database includes a list of user IDs, a list of user attributes and a set of associations between said user IDS and said user attributes.

5. A server as in claim 1, including a second database wherein said second database includes a library of media content.

6. A server as in claim 5, wherein said second database includes a rule for associating at least one said media content with at least one said attribute.

7. A method, including
inserting at least one placeholder in a first media sequence;
sending said first media sequence, including said at least one placeholder to a terminal;
sending a request from said terminal to a server; wherein said request is responsive to said at least one placeholder;
sending at least one second media sequence from said server to said terminal; and
integrating said first media sequence and said at least one second media sequence into a single playback.

8. A method as in claim 7, wherein said placeholder includes a temporo-spatial point in said first media sequence for insertion of said additional media sequence(s) and a location where said additional media sequence(s) may be obtained.

9. A method as in claim 7, wherein said at least one second media sequence is responsive to a set of associations between a database of customized information and a database of identifiers.

10. A method as in claim 9, wherein said database of customized information and said database of identifiers is logically local to said server.

11. A method as in claim 9, wherein said database of customized information includes a set of dynamic and static attributes associated with an end user associated with said terminal.

12. A method as in claim 7, wherein said at least one second media sequence is responsive to personal attributes associated with a user of said terminal.

13. A method as in claim 7, wherein said at least one second additional media sequence is available from said local servers.

14. A method as in claim 7, wherein said step of sending said first media sequence includes multicasting or unicasting.

15. A memory, storing information including instructions, said instructions executable by a processor, said instructions including
an instruction for inserting a placeholder in said first media sequence;
an instruction for sending said first media sequence to a terminal;
an instruction for sending a request from said terminal to a server; wherein said request is responsive to said placeholder;
an instruction for sending a second media sequence from said server to said terminal; and
an instruction for integrating said first media sequence and said second media sequence into a single display.

16. A memory in claim 15, wherein said placeholder includes a temporo-spatial point in said first media sequence for insertion of said second media sequence and a location where said second media sequence may be obtained.

17. A memory as in claim 15, wherein said second media sequence is responsive to a set of associations between a database of personalized information and a database of identifiers.

18. A memory as in claim 15, wherein said database of personalized information and said database of identifiers is logically local to said server.

19. A memory as in claim 15, wherein said database of personalized information includes a set of dynamic and static attributes associated with an end user associated with said terminal.

20. A memory as in claim 15, wherein said second media sequence is responsive to personal attributes associated with a user of said terminal.

21. A memory as in claim 15, wherein said first media sequence includes video on demand.

22. A memory as in claim 15, wherein said step of sending said first media sequence includes multicasting or unicasting.
